(19) United States
(12) Patent Application Publication
(10) Pub. No.: US 2023/0339257 A1
(43) Pub. Date: Oct. 26, 2023

(54) MULTI-COLOR MARKER PEN

(71) Applicant: Mungyo ONS Corporation, Gimhae-si (KR)

(72) Inventor: Myeong Seok NAM, Busan (KR)

(21) Appl. No.: 17/727,529

(22) Filed: Apr. 22, 2022

(51) Int. Cl. B43K 27/08; B43K 24/12

(52) U.S. Cl. CPC B43K 27/08; B43K 24/12

(57) ABSTRACT

Proposed is multi-color marker pen which is composed of a cap (200) and a casing (100) covered by the cap (200). The casing (100) is composed of a linear shaft (110) covered by the cap (200) and having the shape of a hollow body, a sealing part (120) coupled to the upper part of the linear shaft (110) and having a guide (121) formed therein, and a button operation part (130) coupled to the upper part of the sealing part (120). A plurality of tubes (300) is provided in the casing (100), and the upper part of each of the plurality of tubes 300 is coupled to the sealing part (120) in which the guide (121) is formed. The button operation part is composed of three buttons, and by pressing the button operation part (130), the lower part of each of the tubes is ejected through a hole (111) formed in the lower end of the linear shaft (110). In addition, the casing (100) the linear shaft (110) covered by the cap (200) and having the shape of a hollow body, the sealing part (120) coupled to the upper part of the linear shaft (110) and having the guide (121) formed therein, and an operation handle (130) coupled rotatably to the upper part of the sealing part (120). The plurality of tubes (300) is provided in the casing (100), and the upper part of each of the plurality of tubes 300 is coupled to the sealing part (120) in which the guide (121) is formed, and due to the rotation of the operation handle (130), the lower part of each of the tubes is ejected through the hole (111) formed in the lower end of the linear shaft (110). Molten synthetic resin is injected into a mold (1000) composed of an upper mold (1100) and a lower mold (1200) so as to manufacture the casing, the cap, and the operation handle.

### BACKGROUND OF THE INVENTION

### Field of the Invention

The present disclosure relates generally to a multi-color marker pen. More particularly, the present disclosure relates to a multi-color marker pen in which a tube thereof selectively passes through the inside of a guide by a button operation part and is ejected through a hole formed in the lower end of a linear shaft, and the lower part of the linear shaft is configured to be curved in a streamlined shape in a downward direction from an upper portion thereof, and thus when the tube moves down, the tube slides down while being in contact with the inner wall of the linear shaft such that a nib of the tube is protected without being damaged.

### Description of the Related Art

Generally, a writing instrument refers to a ballpoint pen, a signature pen, a highlighter, or a magic pen, and a sealing cap is detachably fixed to most of these instruments so as to prevent a pen nib from drying.

Such a writing instrument largely includes a fixing type writing instrument in which a pen nib is fixed and a cap is used, a rotating type writing instrument in which a portion of a pen nib thereof is moved out of a spiral pipe along the spiral pipe by rotating a portion of a shaft, a knock type writing instrument in which a spring is moved by pressing a portion of a shaft such that a pen nib is moved to the outside, and a protruding/inserting type writing instrument in which a pen nib slides to protrude and retract.

The protruding/inserting type writing instrument has an advantage in that the protruding/inserting type writing instrument can be used without a separate cap being opened and closed, but the protruding/inserting type writing instrument has a disadvantage in that the protruding/inserting type writing instrument can be applied only to a writing instrument using a non-volatile or lowly volatile substance such as oil-based ink since the protruding/inserting type writing instrument has a pen nib through hole simply formed through an end of a side of the writing instrument such that the pen nib protrudes through the pen nib through hole.

On the other hand, a marker pen, white pen, water-based pen, or a highlighter which is highly volatile is required to have a cap opened and closed, and when a pen nib is exposed to air for a long time, ink may dry and the writing instrument may have shortened life or be damaged.

In order to use various colors while using such a writing instrument, a plurality of writing instruments is required to be provided.

There is a multi-color writing instrument made by bundling multiple ballpoint pen nibs having different colors such that the hassle of using multiple writing instruments in turn is solved.

As disclosed in Korean Utility Model Registration No. 20-0452366, a multi-color writing instrument of a prior art has a plurality writing instruments mounted therein, which is selected from multi-color ballpoint pens and a mechanical pencil, a casing having a press piece by which one of the plurality of writing instruments can be selected; and an auxiliary casing having a highlighter provided at a first end thereof and having an eraser provided at a second end thereof, the auxiliary casing being fastened detachably to the casing. The multi-color writing instrument further includes a cap configured to prevent volatilization of the ink of the highlighter.

However, in the multi-color writing instrument described above, the writing instrument such as the highlighter containing volatile ink has ink dried and hardened when being in contact with air, and thus is necessarily provided with the cap. In a case in which a plurality of writing instruments containing volatile ink is simultaneously provided in the casing, when using the multi-color writing instrument, the cap is required to be opened, so even unused writing instruments may be exposed to air, and the cap may be lost.

Meanwhile, in order to solve such a problem, a multi-color writing instrument having a dry prevention means is disclosed in Korean Patent No. 10-1475781, and includes: a first casing part having a plurality of first guide holes formed on an outer circumferential surface thereof in a longitudinal direction thereof and having a receiving cylinder formed on a rear end thereof; an eraser fitted into the receiving cylinder; a second casing part having a plurality of second guide holes formed on an outer circumferential surface thereof in a longitudinal direction thereof and a cover cylinder, which is screwed to the receiving cylinder, formed on a front end thereof; two gap maintenance parts provided in the first casing part and the second casing part, respectively, and having through holes, respectively; a plurality of non-volatile writing members provided in the first casing part and installed by passing through the through hole of the gap maintenance parts; a plurality of volatile writing members provided in the second casing part and installed by passing through the through hole of the gap maintenance parts; a plurality of press parts connected to the non-volatile writing members and the volatile writing members, respectively, and formed by protruding to the outside by passing through each of the first guide holes or each of the second guide holes; a spring part connecting the press parts with the through hole therebetween; a first cover part installed on the front end of the first casing part and allowing each of the non-volatile writing members to be moved in and out of the first cover part; and a second cover part installed on the rear end of the second casing part, and having a sealing part formed thereon such that each of the volatile writing members is moved in and out of the sealing part, wherein a sealing part has a cut part which is transformed elastically and opened when the volatile writing member protrudes to the rear end of the second casing part and which is closed when the volatile writing member is inserted into the second casing part, wherein the cut part is formed in a straight or cross shape.

However, in the multi-color writing instrument, a tube thereof passes through a ticking guide and is withdrawn through a hole formed in the lower end of the lower end of an entire linear shaft, and when the tube moves down, a nib of the tube is damaged.

### SUMMARY OF THE INVENTION

Accordingly, the present disclosure has been made keeping in mind the above problems occurring in the related art, and the present disclosure is intended to propose a multi-color marker pen in which a tube thereof passes through the inside of a guide by pressing a button operation part 130 having multi buttons and is ejected through a hole formed in the lower end of a linear shaft, and the lower part of the linear shaft is configured to be curved in a streamlined shape in a downward direction from an upper portion thereof, and thus when the tube moves down, the outer circumferential surface of a nib fixing part slides down while being in contact with the inner wall of the linear shaft, thereby protecting the nib of the tube such that the nib of the tube is not damaged.

In order to achieve the above objective, according to one aspect of the present disclosure, there is provided a the multi-color marker pen including: a cap 200 and a casing 100 covered by the cap 200, the casing 100 being composed of a linear shaft 110 covered by the cap 200 and having the shape of a hollow body, a sealing part 120 coupled to of an upper part of the linear shaft 110 and having a guide 121 formed therein, and a button operation part 130 coupled to the upper part of the sealing part 120.

A plurality of tubes 300 may be provided in the casing 100, and each of the upper part of the plurality of tubes 300 may be coupled to the sealing part 120 in which the guide 121 is formed, and the button operation part may be composed of multi buttons and by pressing the button operation part 130, the lower part of each of the tubes may be ejected through a hole 111 formed in the lower end of the linear shaft 110.

In addition, in the multi-color marker pen composed of the cap 200, and the casing 100 covered by the cap 200, the casing 100 may be composed of the linear shaft 110 covered by the cap 200 and having the shape of a hollow body, the sealing part 120 coupled to the upper part of the linear shaft 110 and having the guide 121 formed therein, and an operation handle 130 coupled rotatably to the upper part of the sealing part 120.

The plurality of tubes 300 may be provided in the casing 100, and the upper part of each of the plurality of tubes 300 may be coupled to the sealing part 120 in which the guide 121 is formed such that due to rotation of the operation handle 130, the lower part of the tube 300 may be ejected through the hole 111 formed in the lower end of the linear shaft 110.

Accordingly, in the multi-color marker pen of the present disclosure, the tube thereof passes through the inside of the guide due to the pressing of the button operation part 130 having three buttons and is ejected through the hole formed in the lower end of the linear shaft, and the lower part of the linear shaft is configured to be curved in a streamlined shape in a downward direction from an upper portion thereof, and thus when the tube moves down, the outer circumferential surface of a nib fixing part slides down while being in contact with the inner wall of the linear shaft, thereby protecting the nib of the tube such that the nib of the tube is not damaged.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view of a multi-color marker pen according to an embodiment of the present disclosure;

FIG. 2 is an exploded view of the multi-color marker pen of the present disclosure;

FIG. 3 is a perspective view of a tube of the multi-color marker pen of the present disclosure;

FIG. 4 is a cross-sectional view of the tube of the multi-color marker pen of the present disclosure;

FIG. 5 is a picture of a cap of the multi-color marker pen of the present disclosure;

FIG. 6 is a perspective view of a multi-color marker pen according to another embodiment of the present disclosure;

FIG. 7 is an exploded view of the multi-color marker pen of the present disclosure;

FIG. 8 is a perspective view of the tube of the multi-color marker pen of the present disclosure;

FIG. 9 is a cross-sectional view of the tube of the multi-color marker pen of the present disclosure;

FIG. 10 is a cross-sectional view illustrating a state in which a nib is coupled to a body of FIG. 9;

FIG. 11 is a cross-sectional view illustrating a state in which an operation rod is coupled to the body of FIG. 9;

FIG. 12 is a cross-sectional view illustrating a state in which a press member is coupled to the operation rod of FIG. 9;

FIG. 13 is a detailed view of a sealing part of the multi-color marker pen of the present disclosure; and

FIG. 14 is a detailed view illustrating a state in which an operation handle of the multi-color marker pen of the present disclosure is used.

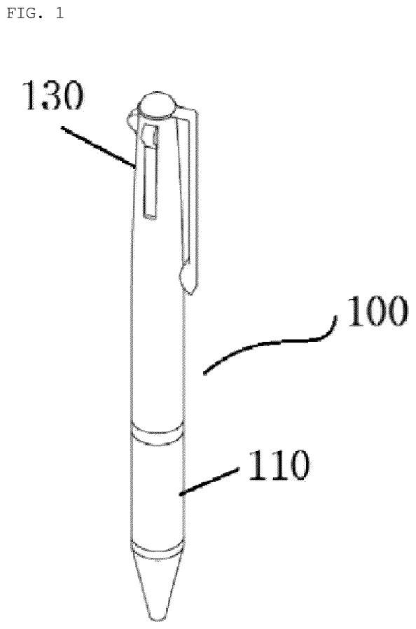

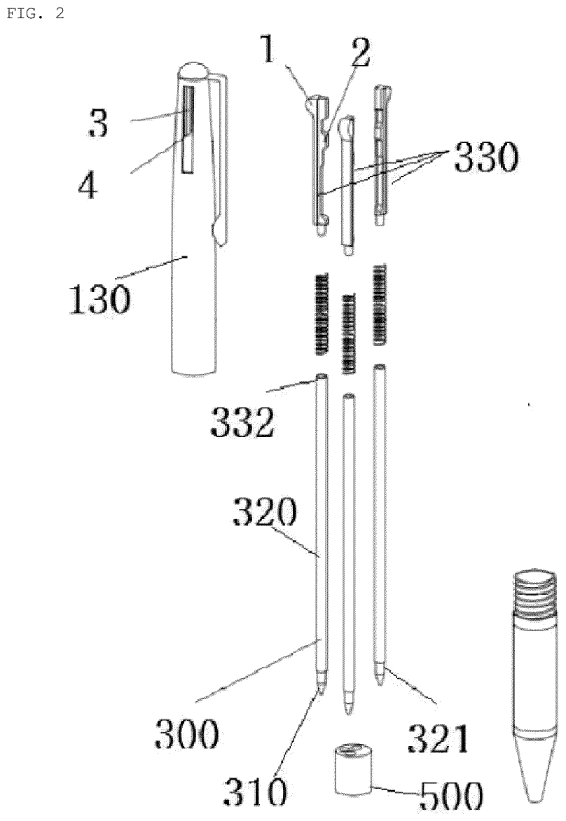

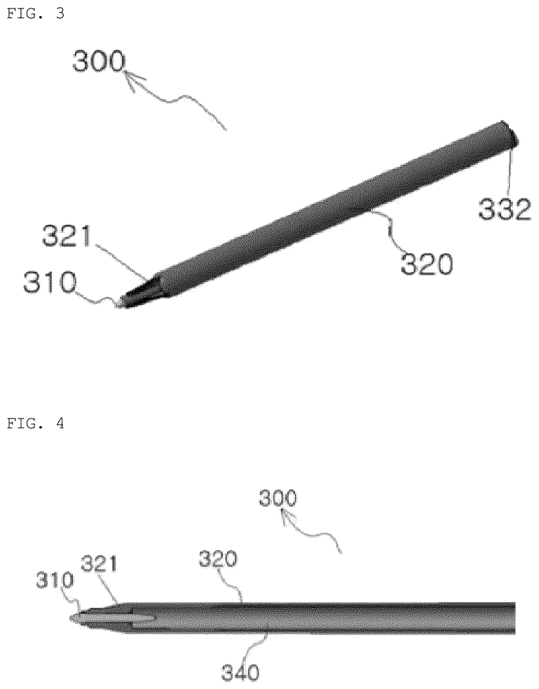

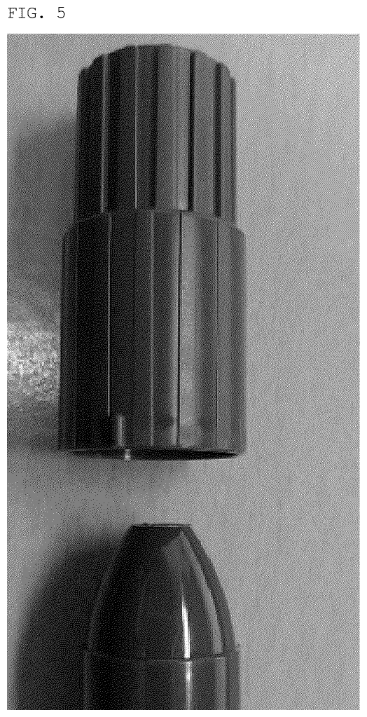

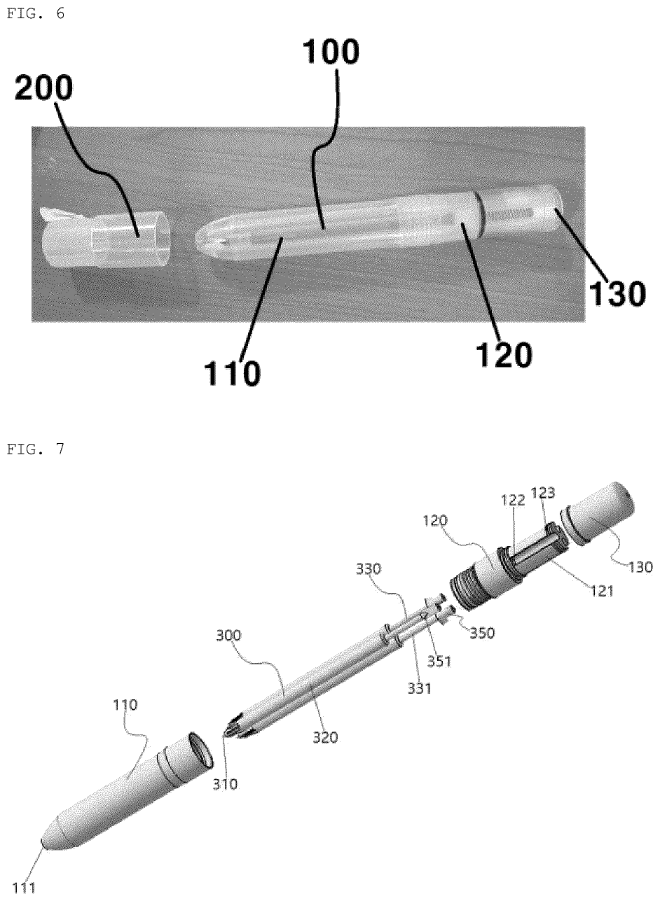

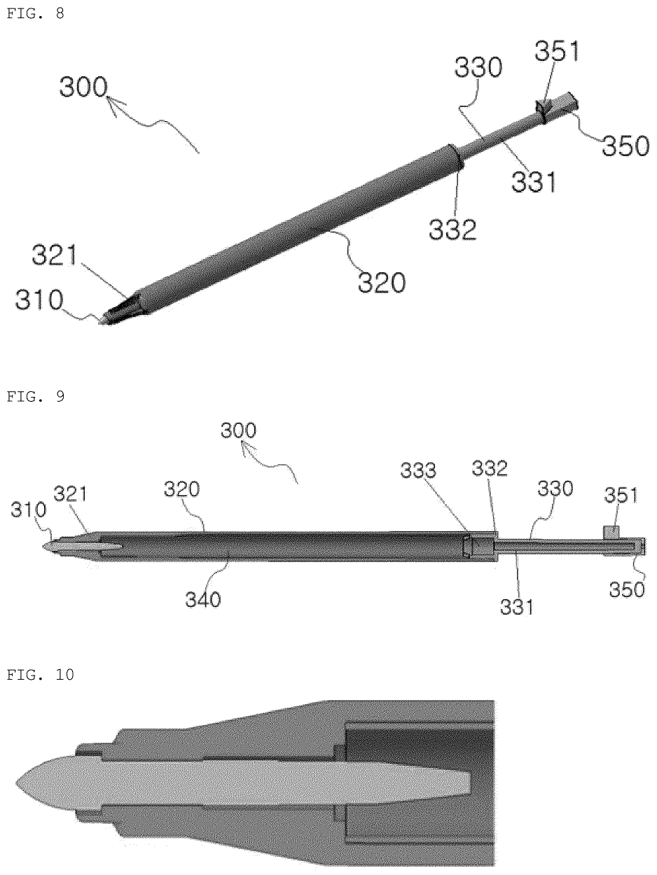

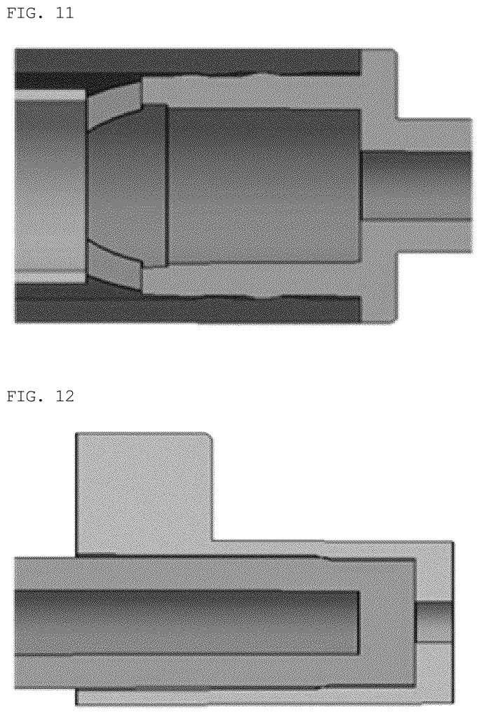

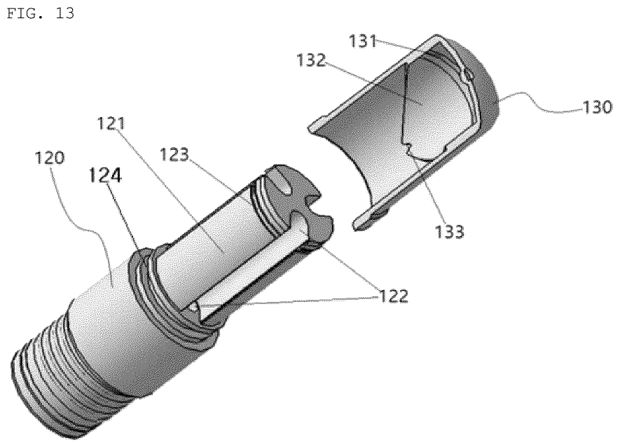

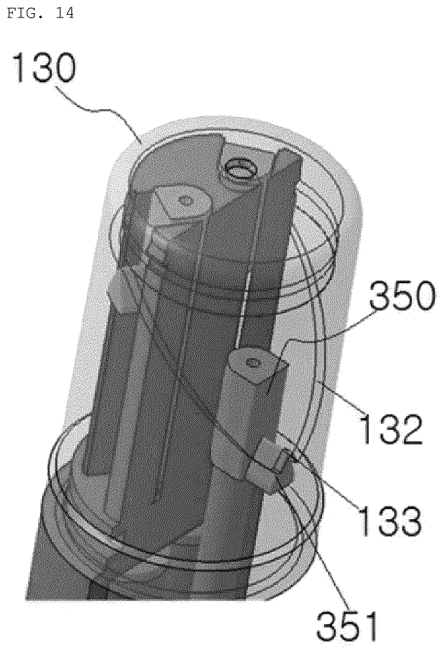

### DETAILED DESCRIPTION OF THE INVENTION

The present disclosure relates to a multi-color marker pen, and particularly, relates to a multi-color marker pen composed of a cap, and a casing 100 covered by the cap.

In the multi-color marker pen according to an embodiment of the present disclosure, the casing 100 is composed of a linear shaft 110 covered by the cap and having a shape of a hollow body, and a button operation part 130 coupled to the upper part of the linear shaft 110 and having three buttons. Due to the pressing of a button operation part 130, each nib is ejected through a hole famed in the lower end of the linear shaft. The lower part of the linear shaft is configured to be curved in a streamlined shape in a downward direction from an upper portion thereof, and thus when the tube moves down, the outer circumferential surface of a nib fixing part slides down while being in contact with the inner wall of the linear shaft, thereby protecting the nib of the tube such that the nib of the tube is not damaged.

The plurality of tubes 300 is provided in the casing 100, and the lower part of each of the tubes is ejected through the hole 111 formed in the lower end of the linear shaft 110 by pressing the upper part of each of the plurality of tubes 300 by the button operation part 130.

Hereinafter, the multi-color marker pen of the present disclosure will be described in detail with reference to the accompanying drawings. The present disclosure relates to the multi-color marker pen composed of the cap, and the casing 100 covered by the cap.

The casing 100 is composed of the linear shaft 110 covered by the cap 200 and having the shape of a hollow body, and the button operation part 130 coupled to the upper part of the linear shaft 110, the button operation part 130 having three buttons and being coupled to the upper part of the linear shaft by being pressed.

The plurality of tubes 300 is provided inside the casing 100, and the lower part of each of the tubes is ejected through the hole 111 formed in the lower end of the linear shaft 110 by pressing the upper part of each of the plurality of tubes 300 by the button operation part.

In addition, the linear shaft 110 is configured to have the shape of a hollow body, and the lower part of the linear shaft 110 is configured to be curved in a streamlined shape, and thus when each of the tubes moves down, each of the tubes slides down while being in contact with the inner wall of the linear shaft such that the nib 310 of the each of the tubes is protected.

Each of the tubes, which has the shape of a hollow body, is composed of a body 320 having the nib fixing part 321 formed on a front end thereof, the nib 310 coupled to the nib fixing part 321 of the body 320, and a marker ink part 340 provided in the body 320 such that a first end of the marker ink part 340 is in contact with the nib 310, and a second end thereof is in contact with an operation rod 330.

The nib is forcibly fitted into the nib fixing part, and when the tube moves down in the longitudinal direction of the casing, the outer circumferential surface of the nib fixing part is required to be moved down while rubbing against the inner wall of the linear shaft, so the nib is configured to be as thin as possible and to have a pointed front end.

In addition, the nib fixing part is configured to be curved in a streamlined shape.

Furthermore, the operation rod is coupled to the upper part of the body.

Additionally, the operation method of withdrawing the tube through the hole formed in the front end of the linear shaft will be described in detail below.

When a user presses the button operation part 130 after removing the cap covering the linear shaft of the casing, a coil spring is compressed. Accordingly, the tube provided inside the casing is ejected through the hole formed in the front end of the linear shaft.

In addition, when restoring the tube to an initial position, a press member is moved upward by the restoring force of the coil spring.

Accordingly, after the tube inserted into the casing is ejected through the hole formed in the front end of the linear shaft, the tube is inserted back into the hole.

Meanwhile, the tube moves up and down inside the casing, and an insertion part of the tube is made of a hard synthetic resin material at opposite ends thereof and is made of a soft synthetic resin material at a center part thereof, so the tube is not broken when the tube slides down while being in contact with the inner wall of the linear shaft.

That is, in the multi-color marker pen of the present disclosure, when a user presses an operation rod press button 1 having one color, the press button moves downward along a button hole 3 and is held in the lower end part 4 of the button hole, and a tube connected with the press button is exposed through the hole to the outside so as to be used.

When a user presses a press button having another color, the press button allows a lower protrusion thereof to push the upper part of the press button which is already pressed while moving down, and the press button which is already pressed is moved upward by being released from the locked state thereof and returns to an initial position thereof, and the press button having the another color is held in the lower end part of the button hole, and a tube having a different color connected thereto is exposed through the hole to the outside so as to be used.

Particularly, unlike a ballpoint pen, a highlighter/a marker pen is required to be sealed, and the sealing is required to be emphasized. The sealing is required to be performed in a cylindrical guide having three holes in which individual tubes operate and O-rings are installed on the perimeters of individual tubes such that the sealing is performed.

Accordingly, in the multi-color marker pen of the present disclosure, when the button operation part is pressed, the tube thereof is ejected through the hole formed in the lower end of the casing the linear shaft, and the lower part of the linear shaft is configured to be curved in a streamlined shape in a downward direction from an upper portion thereof, and thus when the tube moves down, the outer circumferential surface of the nib fixing part slides down while being in contact with the inner wall of the linear shaft, thereby protecting the nib of the tube such that the nib of the tube is not damaged.

A multi-color marker pen according to another embodiment of the present disclosure is composed of the cap 200, and the casing 100 covered by the cap 200.

The casing 100 is composed of the linear shaft 110 covered by the cap 200 and having the shape of a hollow body, a sealing part 120 coupled to the upper part of the linear shaft 110 and having a guide 121 formed therein, and an operation handle 130 coupled rotatably to the upper part of the sealing part 120.

The plurality of tubes 300 is provided inside the casing 100, and the upper part of each of the plurality of tubes 300 is coupled to the sealing part 120 in which the guide 121 is formed, and thus due to the rotation of the operation handle 130, the lower part of each of the tubes is ejected through the hole 111 formed in the lower end of the linear shaft 110.

In addition, a plurality of coupling grooves 134 is formed radially in the outer circumferential surface of the upper end part of the operation handle 130, and a coupling protrusion 210 which can be inserted into each of the coupling grooves formed in the operation handle is formed on the inner circumferential surface of the cap 200. When the operation handle 130 is inserted into the cap 200, the coupling protrusion 210 of the cap 200 is inserted into the coupling groove 134 of the operation handle 130, and when a user rotates the cap 200 by holding the cap 200 by hand, the operation handle 130 can be rotated.

The present disclosure relates to the multi-color marker pen composed of the cap 200 and the casing 100 covered by the cap 200.

The casing 100 is composed of the linear shaft 110 covered by the cap 200 and having the shape of a hollow body, the sealing part 120 coupled to the upper part of the linear shaft 110 and having the guide 121 formed therein, and the operation handle 130 coupled rotatably to the upper part of the sealing part 120.

The plurality of tubes 300 is provided in the casing 100, and the upper part of each of the plurality of tubes 300 is coupled to the sealing part 120 in which the guide 121 is formed, and due to the rotation of the operation handle 130, the lower part of each of the tubes is ejected through the hole 111 formed in the lower end of the linear shaft 110.

In addition, the linear shaft 110 is configured to have the shape of a hollow body, and the lower part of the linear shaft 110 is configured to be curved in a streamlined shape, and thus when each of the tubes moves down, the tube slides down while being in contact with the inner wall of the linear shaft such that the nib 310 of the tube is protected.

The sealing part is coupled to the upper part of the linear shaft, and the sealing part is famed in a cylindrical shape. The guide having a cylindrical shape having a diameter smaller than the diameter of the sealing part is configured to be integrated with the upper part of the sealing part.

Additionally, a threaded surface is formed on the outer circumferential surface of the lower part of the sealing part, and a threaded surface is formed on the inner circumferential surface of the upper part of the linear shaft corresponding thereto. Accordingly, the linear shaft and the sealing part are screwed to each other.

In addition, a plurality of holes 122 is formed radially on the guide, and each of the holes is formed by extending to the lower surface of the sealing part from the upper surface of the guide.

Furthermore, each of the plurality of holes formed in the guide communicates with the outer circumferential surface of the guide in a radial direction, and thus the hole formed in the guide constitutes an opening part of the outer circumferential surface of the guide.

In addition, a groove 123 is formed in the outer circumferential surface of the upper part of the guide in a circumferential direction thereof.

Furthermore, a ring-shaped sealing groove 124 is formed in the sealing part at the lower side of the guide in a circumferential direction thereof, wherein a sealant is coupled to the sealing groove.

Additionally, the operation handle is coupled to the upper part of the sealing part such that the operation handle covers the guide formed to be integrated with the upper part of the sealing part and the sealant.

Accordingly, the sealing part is coupled to the operation handle and seals the casing to prevent air from being introduced into the casing.

In addition, the lower surface of the operation handle is configured to have an open cylindrical shape, and a protrusion 31 is formed on the inner upper part of the operation handle along an inner circumferential surface thereof.

Accordingly, the upper part of the guide is inserted into an opening part formed in the lower surface of the operation handle, and the protrusion formed on the inner circumferential surface of the operation handle is inserted into the groove foamed in the outer circumferential surface of the guide, so the operation handle is coupled to the upper part of the sealing part so as to cover the guide.

In addition, the guide is configured to have a diameter smaller than the inner diameter of the operation handle.

In addition, the operation handle has a guide part 132 formed on a side of an inner circumferential surface thereof by protruding therefrom such that the guide part 132 has width decreasing gradually toward a lower part thereof, wherein a triangle-shaped insertion recess 133 is formed in the lower center of the guide part.

Meanwhile, the tubes are inserted into the casing composed of the linear shaft, the sealing part in which the guide is formed, and the operation handle.

Each of the tubes, which has the shape of a hollow body, is composed of the body 320 having the nib fixing part 321 formed at a front end thereof, the nib 310 coupled to the nib fixing part 321 of the body 320, the operation rod 330 coupled to the upper part of the body 320, the marker ink part 340 provided in the body 320 such that the first end of the marker ink part 340 is in contact with the nib 310, and the second end thereof is in contact with the operation rod 330, and the press member 350 coupled to the upper part of the operation rod 330.

The nib is forcibly fitted into the nib fixing part, and when the tube moves down in the longitudinal direction of the casing, the outer circumferential surface of the nib fixing part is required to be moved down while rubbing against the inner wall of the linear shaft, so the nib is configured to be as thin as possible and to have a pointed front end.

In addition, the nib fixing part is configured to be curved in a streamlined shape.

Furthermore, the operation rod is coupled to the upper part of the body and is composed of a cylinder-shaped insertion part 331 inserted into a hole formed in the sealing part, a circular plate 332 formed on the lower surface of the insertion part and configured to have a diameter larger than the diameter of the insertion part, and a fitting part 333 formed on the lower surface of the circular plate and configured to have a diameter smaller than the diameter of the circular plate.

In this case, the fitting part of the operation rod is forcibly fitted into a hollow hole of the body.

Additionally, the press member is coupled to the upper part of the insertion part of the operation rod and is configured to have a cylindrical shape having an open lower surface, and a triangle-shaped press protrusion 351 is formed on a side of the outer circumferential surface of the press member.

In addition, the upper part of the insertion part of the operation rod is inserted into an opening part formed in the lower surface of the press member, and the insertion part is forcibly fitted into the press member.

In this case, the insertion parts of the plurality of tubes inserted into the casing are inserted respectively into a plurality of holes formed in the sealing part, and the insertion parts inserted into the holes of the sealing part are inserted through the sealing part into holes formed in the guide.

Furthermore, a coil spring and the press member are sequentially inserted into each of the holes formed in the guide, and the insertion part is inserted into the center of the coil spring, and the press member is coupled to the upper part of the insertion part such that the coil spring is not removed therefrom.

Additionally, in the press member coupled to the insertion part, the press protrusion partially protrudes to the outer circumferential surface of the guide.

In addition, a first end of the coil spring is in contact with the upper surface of the sealing part, and a second end of the coil spring is in contact with the lower surface of the operation rod, so the upper surface of the circular plate of the operation rod is in constant contact with the lower surface of the sealing part. Accordingly, the linear shaft and the sealing part of the casing are sealed.

Meanwhile, in the multi-color marker pen of the present disclosure, the front end of the linear shaft of the casing is covered by the cap, and in the rear end of the casing, the operation handle is coupled to the sealing part, so the inside of the casing is sealed.

Therefore, the tube inserted into the casing can be stored in a sealed space, and thus the nib of the tube does not dry.

In addition, when using the tube, the cap covering the linear shaft of the casing is removed therefrom, and the tube inserted into the casing is ejected through the hole formed in the front end of the linear shaft by rotating the operation handle.

Furthermore, the operation method of withdrawing the tube through the hole formed in the front end of the linear shaft will be described in detail below.

When a user rotates the operation handle of the casing clockwise or counterclockwise after removing the cap covering the linear shaft of the casing, the operation handle is rotated, and due to the rotation of the operation handle, the guide part formed in the operation handle is also rotated.

In this case, when the operation handle is rotated, the guide part is rotated, and the press protrusion partially protruding toward the outer circumferential surface of the guide is moved in a downward direction.

In addition, when the press protrusion moves to the lowest part of the guide part, the press protrusion is inserted into the insertion recess of the guide part.

More specifically, the press protrusion is formed in a triangular shape, and when the guide part configured to have width decreasing gradually toward the lower part thereof is rotated, a side surface of the guide part presses one surface of the press protrusion, and the press protrusion moves in a downward direction along the side surface of the guide part.

Additionally, the triangle-shaped press protrusion is inserted into the insertion recess having a triangle shape formed in the lower part of the guide part.

In addition, as the press member moves downward, the coil spring located under the press member is compressed. Accordingly, the tube provided in the casing is ejected through the hole formed in the front end of the linear shaft.

Furthermore, when the operation handle is rotated again, the guide part is rotated and the press protrusion inserted into the insertion recess of the guide part is removed from the insertion recess, and the press member is moved upward by the restoring force of the coil spring.

Accordingly, after the tube inserted into the casing is ejected through the hole formed in the front end of the linear shaft, the tube is inserted back into the hole.

Meanwhile, the tube moves up and down inside the casing, and the insertion part of the tube is made of a hard synthetic resin material at the opposite ends thereof and is made of a soft synthetic resin material at the center part thereof, so the tube is not broken when the tube slides down while being in contact with the inner wall of the linear shaft.

In addition, the plurality of coupling grooves 134 is formed radially in the outer circumferential surface of the upper end part of the operation handle 130, and the coupling protrusion 210 which can be inserted into each of the coupling grooves formed in the operation handle is formed on the inner circumferential surface of the cap 200. When the operation handle 130 is inserted into the cap 200, the coupling protrusion 210 of the cap 200 is inserted into the coupling groove 134 of the operation handle 130, and when a user rotates the cap 200 by holding the cap 200 by hand, the operation handle 130 can be rotated.

What is claimed is:

1. A multi-color marker pen comprising:
a cap, and
a casing (100) covered by the cap, the casing (100) being composed of a linear shaft (110) covered by the cap (200) and having a shape of a hollow body, and a button operation part (130) coupled to an upper part of the linear shaft (110).

2. The marker pen of claim 1, wherein a plurality of tubes (300) is provided inside the casing (100), and a lower part of each of the tubes is ejected through the hole (111) formed in a lower end of the linear shaft (110) by pressing an upper part of each of the plurality of tubes (300) by the button operation part (130).

3. The marker pen of claim 2, wherein a lower part of the linear shaft (110) is configured to be curved in a streamlined shape, and thus when the tube (300) moves down, the tube slides down while being in contact with an inner wall of the linear shaft (110) such that a nib (310) of the tube (300) is protected.

4. A multi-color marker pen comprising:
a cap (200), and
a casing (100) covered by the cap (200), the casing (100) being composed of a linear shaft (110) covered by the cap (200) and having a shape of a hollow body, a sealing part (120) coupled to an upper part of the linear shaft (110) and having a guide (121) formed therein, and an operation handle (130) coupled rotatably to an upper part of the sealing part (120),
wherein a plurality of tubes (300) is provided in the casing (100), and an upper part of each of the plurality of tubes (300) is coupled to the sealing part (120) in which the guide (121) is formed such that due to rotation of the operation handle (130), a lower part of the tube (300) is ejected through a hole (111) formed in a lower end of the linear shaft (110), and molten synthetic resin is injected into a mold (1000) composed of an upper mold and a lower mold so as to manufacture parts of the multi-color marker pen,
a lower part of the linear shaft (110) is configured to be curved in a streamlined shape, and when the tube (300) moves down, the tube (300) slides down while being in contact with an inner wall of the linear shaft (110) such that a nib (310) of the tube (300) is protected,
the sealing part (120) is coupled to the upper part of the linear shaft (110), wherein the sealing part (120) is formed in a cylindrical shape, and the guide (121) having a diameter smaller than a diameter of the sealing part (120) and having a cylindrical shape is configured to be integrated with the upper part of the sealing part (120),
a threaded surface is formed on an outer circumferential surface of a lower part of the sealing part (120), and a threaded surface is formed on an inner circumferential surface of the upper part of the linear shaft (110) corresponding thereto, so the linear shaft (110) and the sealing part (120) are screwed to each other, and
a plurality of holes (122) is formed radially in an upper surface of the guide (121), wherein the holes (122) are formed by extending from the upper surface of the guide (121) to a lower surface of the sealing part (120), and each of the plurality of holes formed in the guide (121) communicates with an outer circumferential surface of the guide (121) in a radial direction, so the hole formed in the guide (121) constitutes an opening part of the outer circumferential surface of the guide (121), and a groove (123) is formed in an outer circumferential surface of an upper part of the guide (121) in a circumferential direction thereof.

5. The marker pen of claim 4, wherein in the sealing part (120), a ring-shaped sealing groove (124) is formed in a lower part of the guide (121) in a circumferential direction thereof, wherein a sealant is coupled to the sealing groove (124), and the operation handle (130) is coupled to the upper part of the sealing part (120) such that the operation handle (130) covers the guide (121) formed to be integrated with the upper part of the sealing part (120) and the sealant, and due to the coupling of the sealing part to the operation handle (130), the sealing part (120) seals the casing so as to prevent air from being introduced into the casing, and the operation handle (130) is formed in a cylindrical shape having an open lower surface, and a protrusion (31) is formed on an inner upper part of the operation handle (130) along an inner circumferential surface thereof such that the upper part of the guide (121) is inserted into an opening part formed in the lower surface of the operation handle (130), and the protrusion formed on the inner circumferential surface of the operation handle (130) is inserted into the groove (123) formed in the outer circumferential surface of the guide (121), so the operation handle (130) is coupled to the upper part of the sealing part (120) so as to cover the guide (121).

6. The marker pen of claim 5, wherein the guide (121) is configured to have a diameter smaller than an inner diameter of the operation handle (130), and
a guide part (132) is formed on a side of the inner circumferential surface of the operation handle (130) by protruding therefrom such that the guide part has a width decreasing gradually toward a lower part thereof, wherein an insertion recess (133) is formed in a lower center of the guide part (132), and the tube is inserted into the casing (100) composed of the linear shaft (110), the sealing part (120) in which the guide (121) is formed, and the operation handle (130).
